(19) United States
(12) Patent Application Publication
(10) Pub. No.: US 2014/0112108 A1
(43) Pub. Date: Apr. 24, 2014

(54) DISPLAY DEVICE

(71) Applicants: Franck-Charles-Cyril Orny, La Chaux-de-Fonds (CH); Johnny Frederic Girardin, Fontaines (CH)

(72) Inventors: Franck-Charles-Cyril Orny, La Chaux-de-Fonds (CH); Johnny Frederic Girardin, Fontaines (CH)

(21) Appl. No.: 14/124,290

(22) PCT Filed: Jun. 14, 2012
(86) PCT No.: PCT/EP2012/061335

§ 371 Date: Dec. 6, 2013

(30) Foreign Application Priority Data
Jun. 16, 2011 (CH) 01023/11

(51) Int. Cl. G04B 19/26; G04B 19/247

(52) U.S. Cl. CPC G04B 19/268; G04B 19/247
USPC 368/18

(57) ABSTRACT

A display device (1) of a clock movement includes a support secured to a supporting structure and on which date numbers are inscribed, a platform mounted such that it can move rotationally on the supporting structure in relation to the support, drive elements for driving the rotation of the platform, a date indicator (18) secured to the platform, a lunar-phase indicator (6) mounted such that it can rotate on the supporting platform, and elements for driving the rotation of the lunar-phase indicator (6) in relation to the date indicator (18).

### TECHNICAL FIELD

The present invention relates to the field of mechanical horology. It more particularly relates to a display device for a clockwork movement making it possible to display both the date and a phase of the moon.

### BACKGROUND OF THE INVENTION

A device allowing this dual display is for example described in patent EP 0,308,793. It comprises a date indicator provided with a toothing with thirty-one teeth, a moon phase indicator secured to a wheel with fifty-nine teeth, an intermediate wheel, rotated by the movement of the watch at a rate of one revolution in twenty-four hours, which causes these indicators to advance by one pitch upon each revolution, and means which, during a predetermined angle of rotation of said intermediate wheel, move the latter toward the toothings of the date indicator, and which, during another predetermined angle of rotation of said intermediate wheel, move the latter toward the wheel with fifty-nine teeth. Such a device is provided in particular for a bracelet watch. However, such a device requires providing a moon phase indicator with small dimensions and close to the central axis of the movement. As a result, the moon phase is not easy to read.

Consequently, one aim of the present invention is to propose a display device making it possible to display both a date and a moon phase originally and offering easy reading of the moon phase using a moon phase indicator with large dimensions.

### BRIEF DESCRIPTION OF THE INVENTION

To that end, and according to the present invention, a display device of a clockwork movement is proposed comprising a frame, and further comprising:
a support secured to the frame and on which the date numbers are inscribed,
a platform rotatably mounted on the frame relative to the support,
means for rotating said platform,
a date indicator secured to said platform,
a moon phase indicator rotatably mounted around its own axis on said platform, and
means for rotating the moon phase indicator relative to the date indicator.

### BRIEF DESCRIPTION OF THE DRAWINGS

The invention will be better understood upon reading the following description of one embodiment, provided as an example and done in reference to the appended drawings, in which:

FIG. 1 is a top view of a display device according to the invention, and

FIG. 2 is a cross-sectional view of the display device along line A-A of FIG. 1.

### DETAILED DESCRIPTION OF THE INVENTION

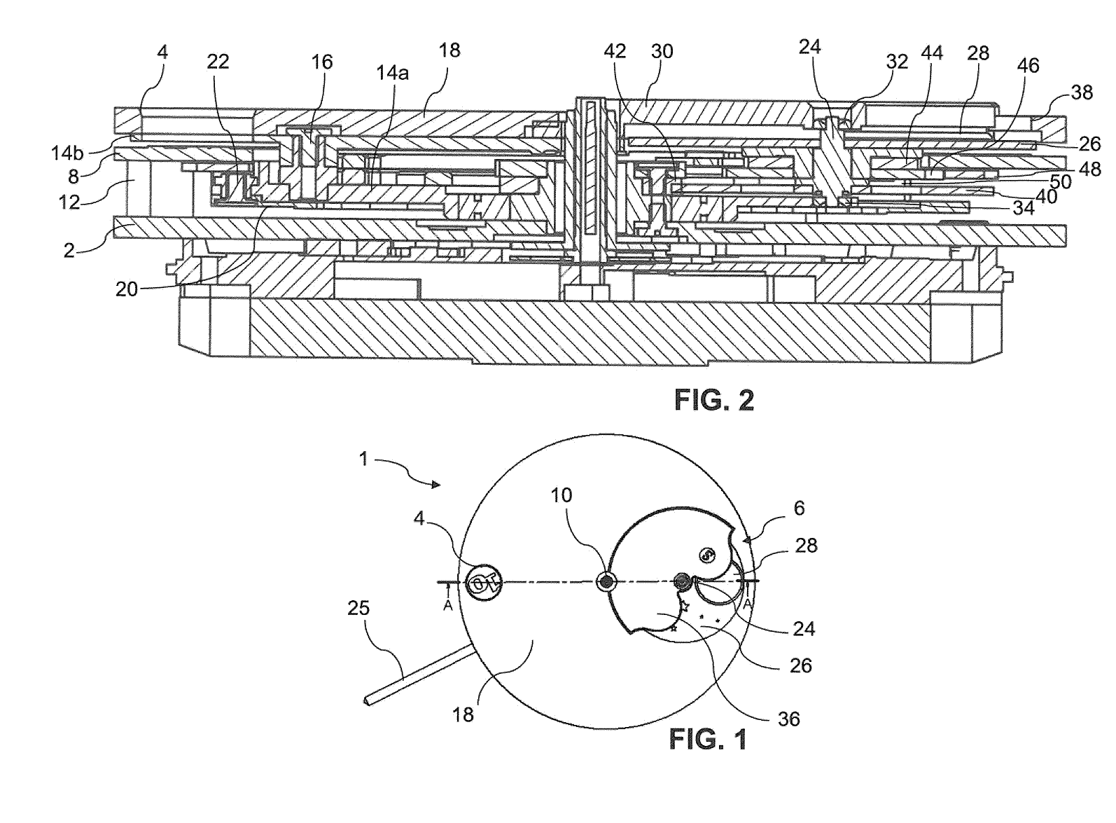

In reference to FIGS. 1 and 2, a display device 1 is shown assuming the form of a module mounted in a clockwork movement. The display device 1 comprises a frame 2, such as the plate of the module, on which the various pieces of the movement are mounted. Only the pieces that are part of the invention will be described hereinafter.

The display device according to the invention is arranged to display both a date using an aperture 4 and the moon phase using a moon phase indicator 6.

According to the invention, the display device 1 comprises a support 8 secured to the frame 2 and on which the date numbers are inscribed. The support 8 assumes the form of a ring coaxial to the axis 10 of the movement and on which the date numbers from 1 to 31 are regularly inscribed. Thus, the support 8 forms a free inner space, the role of which will be described hereinafter.

The support 8 is secured to the frame 2 using pillars 12 regularly distributed around the support.

The display device also comprises a platform rotatably mounted on the frame 2, coaxially to the axis 10 of the movement, relative to the support 8. The platform comprises a lower bar 14a and an upper bar 14b secured using a pillar screw 16. The upper bar 14b comprises an opening aligned with the aperture 4 to allow the reading of the date on the support 8, which is arranged to be positioned below the upper bar 14b, as close as possible to the aperture 4. The lower bar 14a is positioned between the support 8 and the frame 2, such that the lower bar 14a of the platform and the elements that it bears generally fit into the free inner space of the support 8.

The display device also comprises a date indicator secured to the platform. In the embodiment shown here, the date indicator assumes the form of a first disc 18 comprising the aperture 4 to allow a date number to appear. Of course, the aperture may be replaced by any other equivalent display means. For example, the first disc may comprise an annular opening in which the date numbers appear and an index indicating the date number to be displayed. The first disc 18 is positioned coaxially to the axis 10 of the movement and is secured to the upper bar 14b of the platform.

The display device also comprises means for rotating said platform, and therefore the first disc 18, around the axis 10 of the movement, relative to the support 8.

In the illustrated embodiment, the means for rotating the platform comprise a date disc 20 secured to the platform and arranged to cooperate with a date finger secured to a date disc of the clockwork movement. More specifically, the date disc 20 is secured to the lower bar 14a of the platform using a screw 22.

In a known manner, the date disc 20 includes an inner toothing with 31 teeth. Traditionally, the continuous rotation of the hour wheel of the movement causes the date disc 20 to advance by one pitch per day using the date finger provided on the date disc, which in turn is driven by the hour wheel. The operation of such a type of date disc is known by those skilled in the art and will not be described in more detail.

Of course, the means for rotating the platform may assume another embodiment, i.e., for example a train kinematically connected to the hour wheel allowing constant driving of the date disc and therefore the platform. The dimensions and the number of teeth of the elements of the train are calculated to cause the platform, and therefore the first disc 18, to advance by one pitch per day. Thus, the first disc 18 performs one revolution in 31 days. One then has a dragging date additionally making it possible to show day/night information.

The movement also comprises a date corrector device known by those skilled in the art that assumes its functional position when a control organ, for example a winding stem 25, is pulled toward an adjustment position and rotated in a direction.

The display device 1 also comprises a jumper fastened to the lower bar 14a and cooperating with a stationary wheel with 31 teeth coaxial to the axis 10 of the movement. Such a jumper allows correct positioning of the platform.

According to the invention, the moon phase indicator 6 is rotatably mounted around its own axis 24 on the platform. More particularly, the moon phase indicator comprises a second disc 26 with pivot axis 24. A bar 30 is provided secured to the upper bar 14b and comprising a bearing 32 in which one of the pivots of the axis 24 of the moon phase indicator rotates, the other pivot rotating in a bearing 34 provided on the lower bar 14a of the platform. The second disc 26 comprises two diametrically opposite images 28 of the moon, the moon phase indicator then being arranged to rotate by one half-revolution per lunation. The bar 30 assumes a traditional form of a moon phase indicator aperture and comprises two protuberances 36 behind which an image 28 of the moon may appear.

The first disc 18 comprises a cutout 38 allowing the passage and display of the phase indicator 6.

The display device 1 further comprises means for rotating the moon phase indicator 6 around its axis 24 relative to the first disc 18.

According to the invention, the means for rotating the moon phase indicator comprise a satellite wheel 40 secured to the moon phase indicator by its axis 26 and a wheel 42 mounted stationary on the frame 2 coaxially to the axis 10 of the movement. The wheel 42 meshes with the satellite wheel 40, such that it performs a satellite movement, the platform constituting a satellite holder. The number of dimensions of the teeth are chosen such that the satellite wheel 40 performs one revolution in 59 days. The stationary wheel 42 has 31 teeth and the satellite wheel 40 has 59 teeth. Thus, the moon phase indicator 6, in addition to rotating in 31 days around the axis of the movement 10, performs one rotation around its axis 24 in 59 days.

A jumper is provided fastened to the lower bar 14a and cooperating with a wheel 44 with 59 teeth coaxial to the axis 24 of the moon phase indicator, and securely connected to said axis 24. Such a jumper allows accurate positioning of the moon phase indicator 6.

The moon phase indicator 6 is connected to a corrector mechanism comprising a corrector crown supported by the platform, a corrector wheel secured to the moon phase indicator, and a friction system arranged to separate the moon phase indicator from the platform.

More particularly, the moon phase indicator 2 is secured in rotation with a corrector wheel 46, coaxial to the axis of the satellite wheel 40. The corrector wheel 46 meshes with the inner toothing of a corrector crown 48, which in turn is supported by the lower bar 14a of the platform. The corrector crown 48 also includes an outer toothing arranged to mesh with a corrector train that may be actuated by a control organ, for example the winding stem pulled into its adjusting position and rotated in the direction opposite that for correcting the date, so as to be able to move the moon phase indicator into the desired position without moving the platform. To that end, a friction system 50 is provided that secures the corrector wheel 46 to the satellite wheel 40 during normal operation, and makes it possible to separate said corrector wheel 46 from the satellite wheel 40 and therefore the platform when the position of the moon phase indicator must be corrected independently of the date.

Thus, the display device according to the invention allows independent correction of the date and the moon phase. Furthermore, arranging the display of the moon in a satellite form on a platform also displaying the date makes it possible to produce a moon phase indicator with large dimensions, thereby favoring reading of the moon phase. Additionally, the display device according the invention advantageously allows an original display of two related pieces of information, i.e., a date and the moon phase.

1.-9. (canceled)

10. A display device for a clockwork movement comprising a frame, comprising:
a support secured to the frame and on which the date numbers from 1 to 31 are inscribed,
a platform rotatably mounted on the frame relative to the support,
means for rotating said platform,
a date indicator secured to said platform,
a moon phase indicator rotatably mounted on said platform, and
means for rotating the moon phase indicator relative to the date indicator,
wherein the date indicator assumes the form of a first disc comprising an aperture revealing a date number, the first disc being arranged to perform one revolution in 31 days.

11. The display device according to claim 10, wherein the means for rotating the platform comprise a date disc secured to the platform and arranged to cooperate with a date finger secured to a date wheel of the clockwork movement.

12. The display device according claim 10, wherein the means for rotating the moon phase indicator comprise a satellite wheel secured to the moon phase indicator and a wheel mounted stationary on the frame meshing with the satellite wheel, such that it performs a satellite movement, the platform constituting a satellite carrier.

13. The display device according to claim 10, wherein the moon phase indicator comprises a second disc comprising two diametrically opposite images of the moon, the moon phase indicator being arranged to rotate by one half-revolution per lunation.

14. The display device according to claim 10, wherein it comprises a corrector device for the moon phase indicator.

15. The display device according to claim 14, wherein the corrector device comprises a corrector crown supported by the platform, a corrector wheel secured to the moon phase indicator, and a friction system arranged to separate the moon phase indicator from the platform.

16. The display device according to claim 10, wherein it comprises jumpers ensuring positioning of the platform and the moon phase indicator.

17. A timepiece comprising a display device and a frame, said display device comprising:
a support secured to the frame and on which the date numbers from 1 to 31 are inscribed,
a platform rotatably mounted on the frame relative to the support,
means for rotating said platform,
a date indicator secured to said platform,
a moon phase indicator rotatably mounted on said platform, and
means for rotating the moon phase indicator relative to the date indicator,
wherein the date indicator assumes the form of a first disc comprising an aperture revealing a date number, the first disc being arranged to perform one revolution in 31 days.

18. The timepiece according to claim 17, wherein the means for rotating the platform comprise a date disc secured to the platform and arranged to cooperate with a date finger secured to a date wheel of the clockwork movement.

19. The timepiece according claim 17, wherein the means for rotating the moon phase indicator comprise a satellite wheel secured to the moon phase indicator and a wheel mounted stationary on the frame meshing with the satellite wheel, such that it performs a satellite movement, the platform constituting a satellite carrier.

20. The timepiece according to claim 17, wherein the moon phase indicator comprises a second disc comprising two diametrically opposite images of the moon, the moon phase indicator being arranged to rotate by one half-revolution per lunation.

21. The timepiece according to claim 17, wherein it comprises a corrector device for the moon phase indicator.

22. The timepiece according to claim 21, wherein the corrector device comprises a corrector crown supported by the platform, a corrector wheel secured to the moon phase indicator, and a friction system arranged to separate the moon phase indicator from the platform.

23. The timepiece according to claim 17, wherein it comprises jumpers ensuring positioning of the platform and the moon phase indicator.
